(19) United States
(12) Patent Application Publication
(10) Pub. No.: US 2012/0210969 A1
(43) Pub. Date: Aug. 23, 2012

(54) LASER SPARK PLUG FOR AN INTERNAL COMBUSTION ENGINE

(76) Inventors: Friedrich GRUBER, Hippach (AT); Markus Kraus, Wiesing (AT)

(21) Appl. No.: 13/425,571

(22) Filed: Mar. 21, 2012

Related U.S. Application Data
(63) Continuation of application No. PCT/AT2010/000351, filed on Sep. 27, 2010.

(30) Foreign Application Priority Data
Oct. 7, 2009 (AT) A 1579/2009

(51) Int. Cl. F02P 23/04

(52) U.S. Cl. 123/143 B

(57) ABSTRACT

The invention relates to a laser spark plug, comprising a laser light-producing device (2) and a spark plug housing (1) at the end of which facing the combustion chamber an injection lens (10) for injecting laser light into the combustion chamber (30) of an internal combustion engine is arranged, the spark plug housing (1) comprising a fastening zone (7) for fastening the laser spark plug in a cylinder head (17) of the internal combustion engine. A projection (31) on the end of the spark plug housing (1) facing the combustion chamber houses the injection lens (10), the outer diameter (D1) of the projection (31) being smaller in the area of the injection lens (10) than the outer diameter (D2) of the spark plug housing (1) in the fastening zone (7).

The invention concerns a laser spark plug comprising a laser light producing device and a spark plug housing, at whose end towards the combustion chamber there is arranged a coupling-in optical means for coupling laser light into the combustion chamber of an internal combustion engine, wherein the spark plug housing has a fastening region for fastening the laser spark plug in a cylinder head of the internal combustion engine.

The invention further concerns an arrangement including a laser spark plug of the aforementioned kind and a cylinder head having a fixing region for the fastening region of the laser spark plug. Finally the invention concerns an internal combustion engine, in particular a gas engine, comprising such an arrangement.

Laser ignition is an ignition system which is in an intensive development phase and which has fundamental advantages over conventional spark ignition. One of those advantages is the absence of erosive wear and hot corrosion at the spark plug electrodes, which in conventional electric spark ignition, specifically in relation to the high power density levels of modern gas engines, lead to reduced spark plug service lives and thus considerable operating costs. The increase in the power density of the engine, which is one of the main focuses in engine development, does not represent any difficulty for laser ignition.

Laser ignition to which reference is made in this proposed invention comprises a laser spark plug in which the laser light pulse which lasts only a few nanoseconds is produced with sufficiently high energy, wherein the laser light beams issuing from for example a laser crystal are concentrated and focused by way of a suitable optical means and coupled into the combustion chamber by way of a light-transmissive window, the so-called coupling-in optical means or the combustion chamber window, at the end of the laser spark plug, at the combustion chamber side. The plasma spark or ignition spark is produced at the focal point of the laser light beams. The laser ignition system further has an optical pumping device where a quasi-continuous laser light of suitable wavelength is produced, which is passed by way of a glass fiber cable to the laser crystal in the laser spark plug and with which it is activated until the laser pulse is triggered. To ensure optimum and reliable operation of the laser crystal with the integrated optical interfaces and switches it is crucial that the temperature of the laser spark plug at the location of installation of the laser crystal is kept as low as possible. In large high-power gas engines the components delimiting the combustion chamber are subjected to very high thermal loadings, added to that there are often long spark plug shafts in which the spark plugs are fitted and where the wall temperatures are already about 90° C. No higher temperature than a maximum of 130° C. should occur at the laser crystal in operation.

That can be achieved only with difficulty with the geometrical configurations known at the present time of the laser spark plugs, under unfavorable boundary conditions.

Therefore the object of the present invention is to provide devices of the kind set forth in the opening part of this specification, in which those disadvantages are reduced, that is to say in which there are no temperature problems in the region of the laser light producing device, generally a laser crystal.

That object is attained in that arranged at the end of the spark plug housing, that is towards the combustion chamber, is a projection in which the coupling-in optical means is disposed, wherein the outside diameter of the projection is smaller in the region of the coupling-in optical means than the outside diameter of the spark plug housing in the fastening region.

The invention is based on the realisation that heat radiation on to the laser spark plug from the combustion chamber is to be kept as low as possible and the heat is to be dissipated from the spark plug housing to the cylinder head wall by way of a heat-dissipating contact surface area which is as large as possible. By the combustion chamber window being held in a region, namely the projection, which is of a smaller outside diameter than the fastening region, on the one hand less heat is absorbed from the spark plug as the projection is of a smaller area which is exposed to the combustion chamber, in the region of the coupling-in optical means. On the other hand more heat can be dissipated by way of the thicker region of the fastening. The proposed solution is further based on the new realisation that only a relatively small light passage element (coupling-in optical means) is required at the combustion chamber window. The light cone can be of a diameter of less than 5 mm, preferably however about 3 mm, at the surface of the coupling-in optical means, that is at the combustion chamber side. Thus, together with the fastening of the coupling-in optical means in the spark plug housing, an overall outside diameter at the end of the laser spark plug, at the combustion chamber side, of not more than about 8 mm, is required. Furthermore it has been found in the tests for optimising laser ignition that the aim should be to have a numerical aperture which is as high as possible for the optical focusing means, that is to say an aperture angle which is as large as possible for the light cone with the focus as the tip thereof.

It is preferably provided that the fastening region includes a male screwthread, that is to say the spark plug can be fastened in the cylinder head with a screw thread, wherein the projection is arranged after the male screwthread in the direction towards the combustion chamber.

The projection can be for example (at least region-wise) in the shape of a right circular cylinder, the outside diameter of which is then smaller than the outside diameter in the fastening region, preferably of the male screwthread.

To make the laser spark plug of a configuration which is as sealingly seated as possible the projection (at least region-wise) can be in the shape of a truncated cone. Desirably the cylinder head is so shaped that the truncated cone bears in sealingly seated relationship in the receiving region of the cylinder head for the spark plug.

It can further be provided that the ratio of the outside diameter in the fastening region D2 to the smallest outside diameter D1 in the region of the projection is between 1.5 and 2.5.

It can further be provided that the ratio of the length of the projection to the smallest outside diameter in the region of the projection is between 0.8 and 1.2.

It can further be provided that the smallest outside diameter in the region of the projection is between 7 mm and 10 mm.

In accordance with the invention protection is also requested for an arrangement including a laser spark plug of the aforementioned kind and a cylinder head having a fixing region for the fastening region of the laser spark plug. It is further preferably provided that the fixing region has a female screwthread corresponding to the male screwthread of the laser spark plug. In that respect it is preferably provided that the cylinder head has a receiving region for the laser spark plug, which is of such a configuration that the end of the projection, that is towards the combustion chamber, terminates substantially flush with the wall of the combustion chamber.

It can be provided for example that the projection is arranged at least region-wise in sealingly seated relationship in the cylinder head. It can further be provided that arranged in front of the fixing region along the longitudinal axis of the laser spark plug in the direction of the combustion chamber is a sealing element which is of higher thermal conductivity than the spark plug housing, which is heat-conductingly arranged between the cylinder head and the spark plug housing.

Finally it can be provided that arranged after the fixing region along the longitudinal axis in the direction of the combustion chamber is a sealing element which is of higher thermal conductivity than the spark plug housing and which is heat-conductingly arranged between the cylinder head and the spark plug housing.

For even better heat dissipation there can be provided a cooling passage which at least region-wise surrounds the fixing region. It can also be provided that this cooling passage also at least partially surrounds the projection.

In summary it can be said that the proposed solution according to the invention provides that the laser spark plug has a projection, for example a cylindrical and/or frustoconical projection, forming the end part of the laser spark plug, towards the combustion chamber. Adjoining the projection rearwardly is an enlargement portion which can serve as a sealing seat surface and for heat dissipation. That sealing seat can be either a flat sealing seat or a conical sealing seat. That sealing seat is in turn adjoined by the fastening region, preferably a male screwthread, serving for fastening the laser spark plug to the internal combustion engine or screwing it thereinto. The fastening region or the male screwthread of the laser spark plug terminates upwardly for example with a screw-in portion, for example a hexagon. For additional heat conduction, a very soft-elastic support ring of material which is a very good heat conductor can be provided at that location.

All the stated features essentially serve to provide that the heat input surface from the combustion chamber is relatively small because of the small end diameter, at the combustion chamber side, of the laser spark plug, and a large part of the heat transmitted to the laser spark plug is dissipated into the preferably water-cooled cylinder head wall. Optionally provided heat-dissipating, preferably areal sealing elements and heat-conducting sealing elements which are arranged at a very small spacing relative to the end towards the combustion chamber of the laser spark plug for example in the form of a support ring between the screw-in portion (for example hexagonal shoulder) and fixing region or cylinder head wall, also involving a large surface area, promote the dissipation of heat into the cylinder wall.

It is thus possible to ensure that the heat is dissipated over a very wide and long laser spark plug region into the cylinder head wall, wherein with decreasing temperature of the cylinder wall at an increasing distance relative to the combustion chamber surface, the temperature of the spark plug housing decreases in the same way as the cylinder wall, and has only a slight excess in relation to the engine cooling water temperature at the location of the contact surface.

In principle the laser spark plug could also be so designed that beneath the fastening region it only involves heat dissipation through a sealing element in the form for example of a soft-elastic contact ring and above the threaded portion a sealing element as a sealing seat (with a corresponding seal between the contact surface and the spark plug housing shoulder). The advantage of the solution with a sealing seat between the fastening portion and the coupling-in optical means however lies in the better sealing action due to the smaller sealing seat surface, as for example in the case of the flat seal, or due to the larger heat dissipation surface with a correspondingly advantageous pressure in relation to surface area when using a conical sealing seat.

The invention further concerns an internal combustion engine, in particular a gas engine, having an arrangement of the aforementioned kind. That gas engine is preferably an engine which is operated on the basis of the Otto cycle, with at least one reciprocating piston/cylinder arrangement. Generally however this involves multi-cylinder internal combustion engines.

Further advantages and details of the invention are described with reference to the accompanying Figures and the specific description relating thereto. In the Figures:

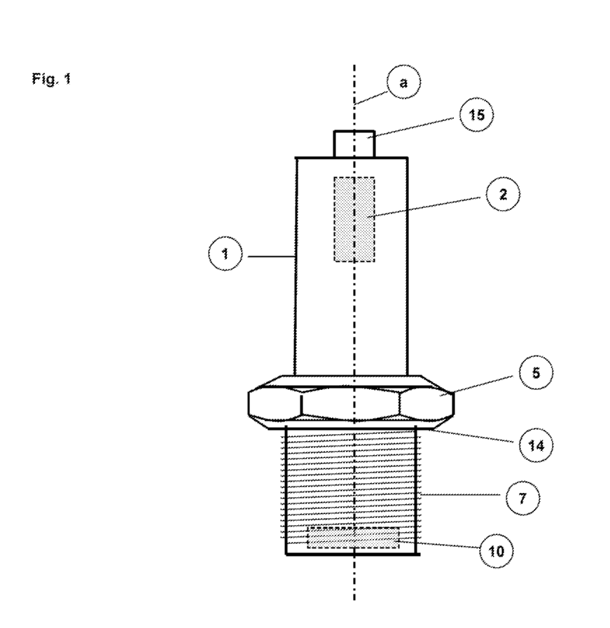

FIG. 1 shows a laser spark plug according to the state of the art,

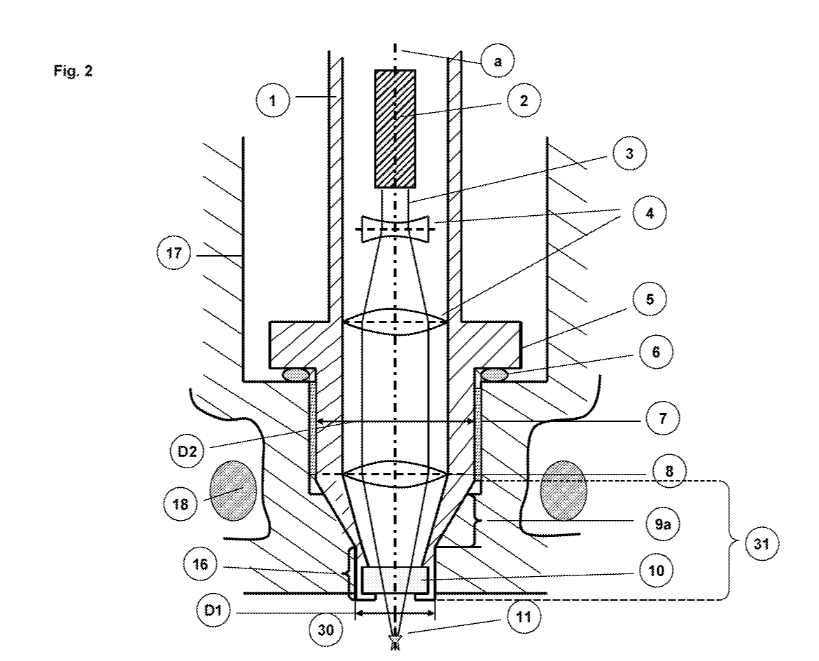

FIG. 2 shows an example according to the invention of a laser spark plug,

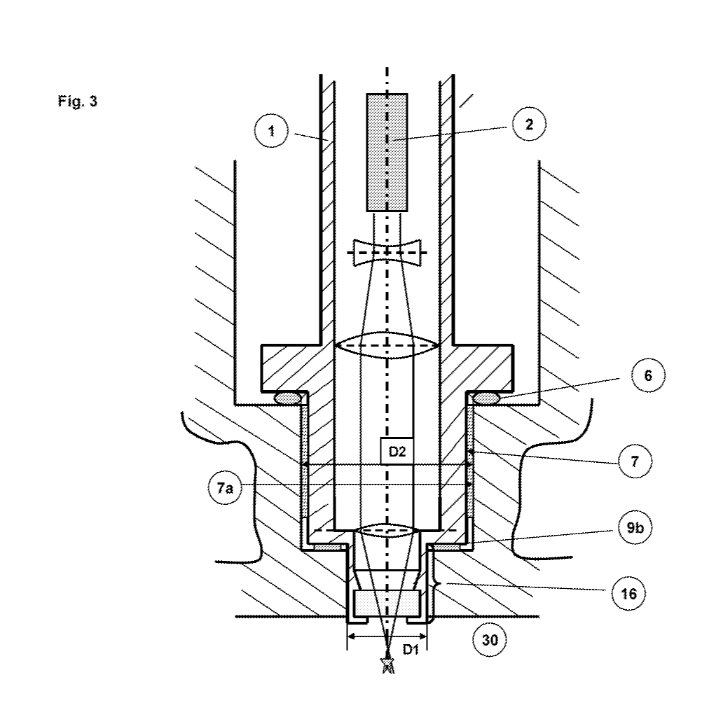

FIG. 3 shows a further example according to the invention of a laser spark plug,

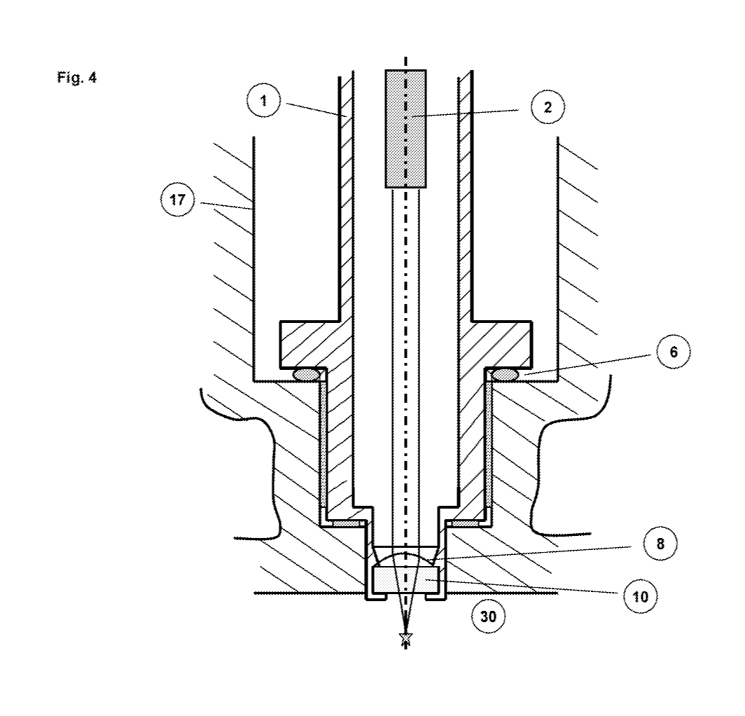

FIG. 4 shows a simplified example of a laser spark plug as shown in FIG. 3,

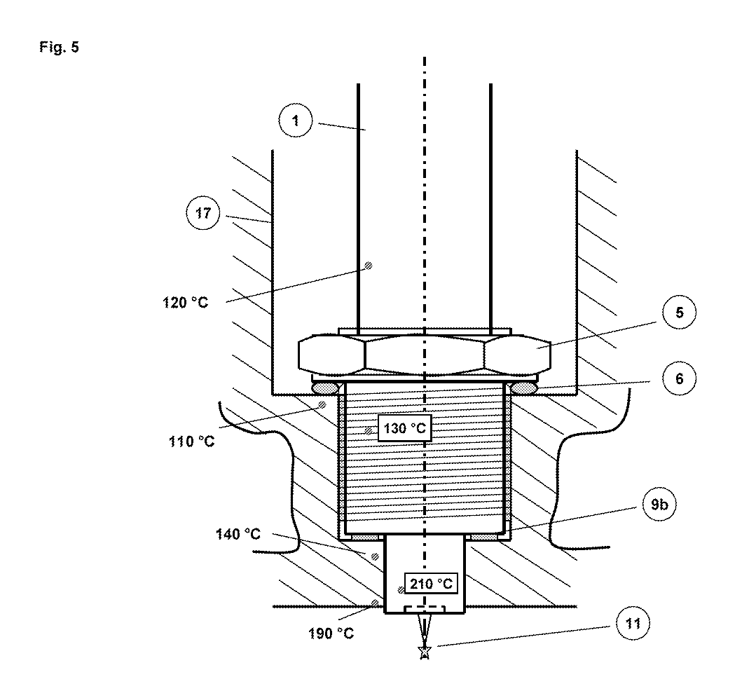

FIG. 5 shows the temperature variation in the operating condition with the laser spark plug of FIG. 3, and

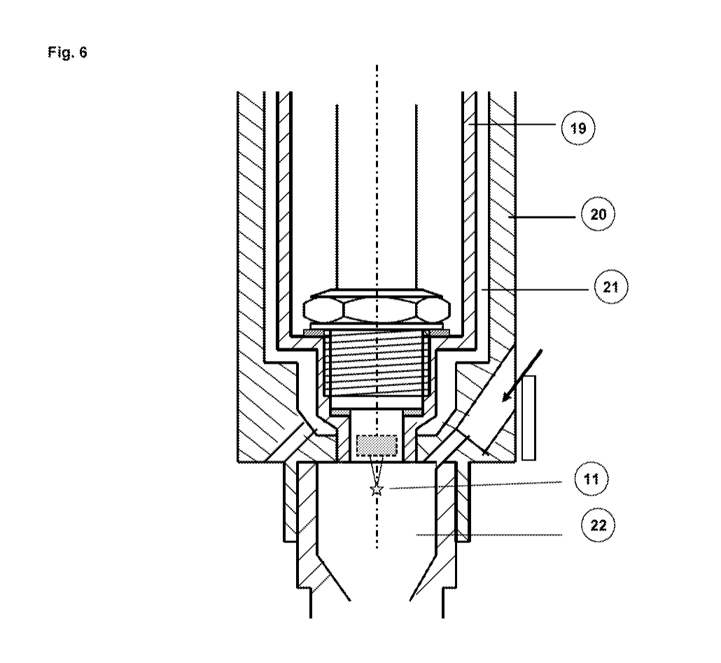

FIG. 6 shows a last example of a laser spark plug.

FIG. 1 diagrammatically shows a laser spark plug in accordance with the state of the art. It includes a spark plug housing 1 extending along the longitudinal axis of the laser spark plug a. The coupling-in optical means 10—also referred to as the combustion chamber window—is arranged at an end, (more specifically the end towards the combustion chamber) of the laser spark plug. The coupling-in optical means 10 is responsible for coupling the laser light produced by a laser light producing device 2 into the combustion chamber of the internal combustion engine. The laser light producing device 2 in this case is in the form of a monolithic solid-state laser (laser crystal) and is fed by a pump light source (not shown). Disposed at the connection (upper) end of the laser spark plug is a connection portion 15 for introducing the pump light.

Disposed at the end of the laser spark plug, towards the combustion chamber, is a fastening region 7 in the form of a male screwthread 7 for screwing into the cylinder head of an internal combustion engine. The coupling-in optical means 10 is surrounded by the fastening region 7, that is to say the male screwthread. For more easily fastening the laser spark plug in the cylinder head, there is further provided a screw-in portion 5 in the form of a hexagon which permits fastening or release of the laser spark plug with a tool for screwing, such as for example a fixed-jaw wrench. A flat sealing seat 14 which adjoins the fastening region 7 along the longitudinal axis a in the direction of the connection end is responsible in the installed condition for the dissipation of heat from the laser spark plug to the cylinder head.

FIG. 2 shows the laser spark plug according to the invention with cylinder head 17 (in each case partly broken away). The laser spark plug includes a spark plug housing 1 which extends along the longitudinal axis a and in which is arranged a laser light producing device 2. The laser spark plug along the longitudinal axis a has a combustion chamber end which in the installed condition extends into the combustion chamber 30 of an internal combustion engine, and a connection end (upward in the drawing, not shown in detail; attention is directed to FIG. 1 which has the same structure at the connection end), serving for the connection of a pump light source. Arranged at the combustion chamber end of the laser spark plug is the coupling-in optical means 10 which is held in the spark plug housing 1 in positively locking relationship.

In addition there is a laser light producing device 2 in the form of a monolithic solid-state laser (laser crystal). The laser light producing device 2 produces laser light, the beam path 3 of which is illustrated. The laser light is expanded in optical elements 4 so that this results in a larger beam diameter. A focusing lens 8 focuses the laser light towards the coupling-in optical means 10 which permits the light to issue from the laser spark plug, and finally on to the focal point 11 in the combustion chamber 30 where the ignition spark is produced in the operating condition. The spark plug housing 1 has a fastening region 7 in the form of a male screwthread making a releasable fastening to the cylinder head 17 by way of the fixing region 7a. The fixing region 7a is in the form of a female screwthread 7a corresponding to the male screwthread 7. A projection 31 in which the coupling-in optical means 10 is arranged extends along the longitudinal axis a in the direction of the combustion chamber 30 and more specifically at the combustion chamber end of the laser spark plug. The coupling-in optical means 10 is arranged in the projection 31 which adjoins the threaded region 7 towards the combustion chamber. In this case the projection 31 has a frustoconical first region in which the spark plug housing bears against the cylinder head 15 in sealingly seated relationship in a throat 9a. Adjoining the frustoconical region there is also a circular-cylindrical region 16 in which the coupling-in optical means 10 is held in positively locking relationship.

In addition a sealing element 6 is arranged in the direction of the connection end of the laser spark plug immediately after the threaded region 7 but still before the screw-in portion 5 in the form of a hexagon. The sealing element 7 is in the form of a soft-elastic, heat-dissipating contact ring and bears against a flat sealing seat. It can be clearly seen that the outside diameter D2 in the threaded region 7 is larger than the maximum outside diameter D1 in the region of the projection 31 at the coupling-in optical means 10.

A cooling passage 8 surrounds both the threaded region 7 and also the projection 31 and dissipates heat by way of a cooling fluid (such as cooling water). The receiving region in the cylinder head 17 for the laser spark plug is of such a configuration that the laser spark plug can be introduced in such a way that the combustion chamber end of the projection 31 terminates substantially flush with the wall of the combustion chamber 30.

FIG. 3 shows an embodiment differing from the embodiment of FIG. 2 in the form of the projection 31 and of the sealing elements 9b. The projection 31 is more specifically of a circular-cylindrical shape over the entire length 16, wherein the outside diameter D1 is again markedly smaller than the outside diameter D2 in the threaded region 7. Instead of the sealingly seated frustoconical region for heat dissipation a sealing element 9b is also arranged after the fastening region 7 beside the sealing element 8 along the longitudinal axis a of the laser spark plug in the direction of the combustion chamber 30.

FIG. 4 shows an embodiment differing from the FIG. 3 embodiment in that there are no optical elements 4 for expanding the laser beam diameter.

FIG. 5 shows ascertained temperature values along the laser spark plug of FIG. 3 in ° C. In comparison with the high temperatures of over 200° C. occurring at the coupling-in optical means 10 at the combustion chamber 30 the shape according to the invention of the laser spark plug and the provision of sealing elements 6, 9b which are of higher thermal conductivity than the spark plug housing 1 can provide that heat is quickly and efficiently dissipated in the direction of the laser light producing device 2 (not shown here). That protects the laser light producing device 2 from premature wear.

FIG. 6 additionally shows a structure having a separate spark plug receiving means comprising an inner housing 19 and an outer housing 20. A fluid can be introduced between the inner housing 19 and the outer housing 20 and cools the laser spark plug with a cooling device. The laser spark plug however could also be heated for example when being brought into operation by means of a heating device to more rapidly reach operating temperature. This example also has a prechamber 22 in which a fuel/air mixture is ignited, that ignited mixture then passing into the actual combustion chamber 30 and there causing combustion of the fuel/air mixture.

1. A laser spark plug comprising a laser light producing device and a spark plug housing, at whose end towards the combustion chamber there is arranged a coupling-in optical means for coupling laser light into the combustion chamber of an internal combustion engine, wherein the spark plug housing has a fastening region for fastening the laser spark plug in a cylinder head of the internal combustion engine, characterised in that arranged at the end of the spark plug housing, that is towards the combustion chamber, is a projection in which the coupling-in optical means is disposed, wherein the outside diameter (D1) of the projection is smaller in the region of the coupling-in optical means than the outside diameter (D2) of the spark plug housing in the fastening region.

2. A laser spark plug as set forth in claim 1 characterised in that the fastening region includes a male screwthread and the projection is arranged after the male screwthread in the direction at the combustion chamber side.

3. A laser spark plug as set forth in claim 1 characterised in that the projection is at least portion-wise in the shape of a right circular cylinder.

4. A laser spark plug as set forth in claim 1 characterised in that the projection is at least portion-wise in the shape of a truncated cone.

5. A laser spark plug as set forth in claim 1 characterised in that the ratio of the outside diameter (D2) in the fastening region to the smallest outside diameter (D1) in the region of the projection is between 1.5 and 2.5.

6. A laser spark plug as set forth in claim 1 characterised in that the ratio of the length (H1) of the projection to the smallest outside diameter (D1) of the projection is between 0.8 and 1.2.

7. A laser spark plug as set forth in claim 1 characterised in that the smallest outside diameter (D1) in the region of the projection is between 7 mm and 10 mm.

8. An arrangement comprising a laser spark plug as set forth in claim 1 and a cylinder head having a fixing region for the fastening region of the laser spark plug.

9. An arrangement as set forth in claim 8 characterised in that the fixing region includes a female screwthread corresponding to the fastening region in the form of a male screwthread of the laser spark plug.

10. An arrangement as set forth in claim 8 characterised in that the cylinder head has a receiving region for the laser spark plug, which is of such a configuration that the end of the projection, that is towards the combustion chamber, terminates substantially flush with the wall of the combustion chamber.

11. An arrangement as set forth in claim 8 characterised in that the projection is arranged at least region-wise in sealingly seated relationship in the cylinder head.

12. An arrangement as set forth in claim 8 characterised in that arranged in front of the fixing region along the longitudinal axis (a) of the laser spark plug in the direction of the combustion chamber is a sealing element which is of higher thermal conductivity than the spark plug housing and which region-wise heat-conductingly connects the cylinder head and the spark plug housing.

13. An arrangement as set forth in claim 8 characterised in that arranged after the fixing region along the longitudinal axis (a) in the direction of the combustion chamber is a sealing element which is of higher thermal conductivity than the spark plug housing and which region-wise heat-conductingly connects the cylinder head and the spark plug housing.

14. An arrangement as set forth in claim 8 characterised in that there is provided a cooling passage which at least region-wise surrounds the fixing region.

15. An arrangement as set forth in claim 14 characterised in that the cooling passage also at least partially surrounds the projection.

16. An arrangement as set forth in claim 8 characterised in that there is provided a prechamber into which the coupling-in optical means opens.

17. An arrangement as set forth in claim 8 characterised in that arranged between the cylinder head and the laser spark plug is a spark plug receiving means having a cooling device and/or heating device which cools and/or heats the laser spark plug.

18. An arrangement as set forth in claim 17 characterised in that the spark plug receiving means has an inner housing and an outer housing, wherein a fluid can be region-wise introduced between the inner housing and the outer housing.

19. An internal combustion engine, in particular a gas engine, comprising an arrangement as set forth in claim 8.
